(19) United States
(12) Patent Application Publication
(10) Pub. No.: US 2024/0122205 A1
(43) Pub. Date: Apr. 18, 2024

(54) METHOD FOR PRODUCING PROTEIN MATERIAL

(71) Applicant: MARS, INCORPORATED, McLean, VA (US)

(72) Inventors: Luis MOLINA, Aimargues (FR); Lahcene GUEDIDER, Aimargues (FR); Mélanie TREHIOU, Aimargues (FR); Mathieu MAO, Aimargues (FR)

(73) Assignee: MARS, INCORPORATED, McLean, VA (US)

(21) Appl. No.: 18/277,758

(22) PCT Filed: Feb. 16, 2022
(86) PCT No.: PCT/US2022/016501

§ 371 Date: Aug. 17, 2023

(30) Foreign Application Priority Data
Feb. 17, 2021 (FR) FR2101529

(51) Int. Cl. A23J 1/00; A23J 1/02; A23K 10/26; A23K 20/147; A23K 50/40

(52) U.S. Cl. CPC A23J 1/002; A23J 1/02; A23K 10/26; A23K 20/147; A23K 50/40

(57) ABSTRACT

The present disclosure relates to methods for treating at least one source of proteins, treated protein material obtainable by said method of treatment, and food compositions for animals, preferably for pets, including said treated protein material.

### TECHNICAL FIELD

The present invention relates to the field of animal proteins and methods of treatment thereof. More precisely, the animal proteins of the present invention can be obtained by methods for treating at least one source of proteins comprising several steps in order to improve the palatability of the animal protein advantageously. The animal proteins or treated protein material according to the present description can be used in combination with other components to form, for example, a food composition for animal consumption.

### PRIOR ART

Manufactured food compositions represent a very widely used means for feeding animals, especially pets. There is a strong demand from companies in this sector for solutions for production of animal proteins that are highly palatable, while reducing the costs of production. It has been shown for many years that animal-based meals, for example poultry-based meals, may have different effects on palatability for dogs and cats. In general, the manner of preparing protein has a sensory effect on the protein material obtained—it depends on whether the protein material is prepared by reuse of animal waste by a dry method or reuse of animal waste by a wet method. These methods of reusing waste from the agriculture and food industry are also called “rendering”. All rendering involves the application of heat, extraction of moisture and separation of fats.

It is well known that multiple factors may contribute to differences in palatability performance. In certain cases, a dry method may have lower performance then a wet method.

The future for rendering is to develop wet methods, in particular because the latter require less energy and thus are less expensive.

Consequently, there is a need to find new solutions for producing better animal proteins obtained by wet methods for treating sources of animal proteins.

Furthermore, there is a need to develop a protein material with a low ash content; said protein material is produced more easily by a wet method than by a dry method.

There is also a need to develop cheaper, quicker methods for producing protein material.

There is also a need to provide methods of obtaining treated protein material that increase the palatability of food compositions for consumption by an animal.

There is also a need to provide methods for increasing the ingestion rate of a food composition for animal consumption.

There is also a need to provide methods for obtaining treated protein material which require less energy than known methods for obtaining treated protein material.

There is also a need to provide methods for obtaining treated protein material which are less expensive than known methods for obtaining treated protein material.

The present disclosure aims to satisfy some or all of these needs.

### DISCLOSURE

The present disclosure relates to a method for treating at least one source of proteins comprising: (a) heating at least one source of proteins, in particular a source of animal proteins; (b) separating the material obtained in step (a) into a solid component (i) and a liquid component (ii); (c) drying the solid component (i); and (d) physical grinding of the material obtained in step (c); wherein step (c) can be performed on the solid component (i) without reintroducing the liquid component (ii).

It is another object of the present disclosure to provide other methods for obtaining a treated protein material which allows to enhance the palatability of a food composition.

It is another object of the present disclosure to provide a treated protein material obtainable by such methods whereas a food composition comprising such a treated protein material.

### SUMMARY

The present disclosure relates to a method for treating at least one source of proteins, said method comprising the following steps:
(a) heating at least one source of proteins, in particular a source of animal proteins;
(b) separating the material obtained in step (a) into a solid component (i) and a liquid component (ii);
(c) drying the solid component (i); and
(d) physical grinding of the material obtained in step (c);
characterized in that step (c) is performed on the solid component (i) without reintroducing the liquid component (ii).

The present description also relates to methods for treating sources of animal proteins for producing treated protein material. This treated protein material can be used in combination with other components to form food compositions for animals. It was found, surprisingly and advantageously, that elimination of the liquid component, normally added during the step of drying the solid component, can led to an increase in palatability of the treated protein material. In fact, by eliminating the step of reintroducing the liquid, in accordance with the present disclosure, the deterioration in the taste of the protein material can be favorably reduced or prevented. Furthermore, the quality of the food compositions for animals can be improved, obtaining protein material that are more palatable from these sources of treated animal proteins.

According to one embodiment, a source of proteins can be an animal source. According to one embodiment, a source of proteins can be poultry, such as, without limitation, chicken.

According to one embodiment, a source of proteins can be selected from bones, carcasses, internal organs, necks and/or heads, or a combination thereof.

According to one embodiment, a source of proteins can be ground to a desired maximum particle size before step (a).

According to one embodiment, the liquid component (ii) can then be treated to supply a solid fraction (iii) and a liquid fraction (iv), and component (iii) is then combined with component (i) before step (c) or step (d).

According to one embodiment, step (a) can comprise heating at least one source of proteins to a temperature at which the fat contained in the source of proteins are molten. In one embodiment, the heating can be done at a temperature from about 80° C. to about 110° C., and/or preferably for about 15 minutes to about 45 minutes.

According to a preferred embodiment, the heating of at least one source of proteins can be performed at a temperature of about 90° C. and/or for about 30 minutes.

According to one embodiment, step (b) can be performed using a screw press, a Tricanter (three-phase decanter), a decanter or any other suitable equipment, preferably a screw press.

According to a more preferred embodiment, step (b) can be performed using a double-screw press and all combinations thereof.

According to one embodiment, step (c) can be performed in a dryer, such as, without limitation, a continuous dryer.

According to one embodiment, step (c) can be performed in a dryer preferably operating at a temperature between about 65° C. and about 145° C.

According to a preferred embodiment, step (c) can be performed in a continuous dryer preferably operating at a temperature between about 65° C. and about 145° C. under vacuum.

According to another of its aims, the present description also relates to a treated protein material obtainable by the method of the present description.

According to another of its aims, the present description also relates to a method for preparing a food composition for animals, such as pets, comprising the following steps: (I) mixing a protein material according to the present disclosure with suitable ingredients for preparing a food composition for animals, and (II) treating the mixture to supply a food composition for animals.

According to another of its aims, the present description also relates to a food composition for animals, such as pets, obtainable by the method of the present description, preferably a composition that is highly palatable for animals.

In particular, the food composition can be a composition in pieces in a sauce or a jelly, preferably in a sauce, a composition/product as a mousse or pate or a tidbit.

In particular, the food composition can be a foodstuff for cats and/or dogs.

According to another embodiment, the food composition can be a packaged individual portion.

The foregoing has made it possible to disclose in broad outlines the features and the technical advantages of the present disclosure so that the detailed description given hereunder can be better understood.

The additional features and advantages of the subject matter of the present description, which forms the subject matter of the claims of the application, will be described hereunder.

A person skilled in the art will know that the conception and the specific execution of the subject matter of the present description can easily be used as a basis for modifying or devising other embodiments with a view to achieving the same aims as those of the present description.

A person skilled in the art will also understand that such equivalent constructions do not deviate from the spirit and scope of the description as presented in the accompanying claims.

### BRIEF DESCRIPTION OF THE DRAWINGS

FIG. 1 shows a flowsheet of the method for treating at least one source of proteins in order to obtain a treated protein material.

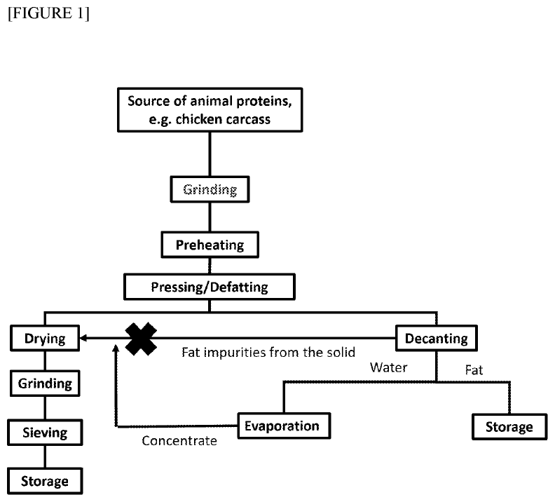

FIG. 2 shows a diagram illustrating the palatability of a food composition for animals comprising a treated protein material as obtained by the method of the present description, compared with a control food composition (control) and the best-known food composition in terms of palatability: roast chicken. Abscissa: (a1) control food composition (“control”), (a2) roast chicken, (a3) food composition comprising the treated protein material according to the present description. Ordinate: Amount of food composition consumed by the animal, expressed as a percentage of the amount of food composition made available. Each test was performed 2 times (T1, T3). VHS: very significant (p-value<0.001), S: significant (p-value<0.05), NS: not significant.

FIG. 3 shows a diagram illustrating the palatability of a food composition for animals comprising a treated protein material as obtained by the method of the present description, compared with a control food composition (control) and the best-known food composition in terms of palatability: roast chicken. Abscissa: (a1) control food composition (“control”), (a2) roast chicken, (a3) food composition comprising the treated protein material according to the present description. Ordinate: Amount of food composition consumed by the animal as a percentage. Each test was performed 2 times (T1, T3). VHS: very significant (p-value<0.001), S: significant (p-value<0.05), NS: not significant.

FIG. 4 shows a diagram illustrating the palatability of test food compositions for animal consumption comprising a treated protein material as obtained by the methods of the present description, compared with a control food composition (control). Abscissa: (Control) control food composition, (Bic meal) Food composition comprising commercially available treated protein material, (No condensate) food composition comprising the treated protein material obtained by the “no condensate” method, (Liver) food composition comprising the treated protein material obtained by the “liver” method, (AA+sugars) food composition comprising the treated protein material obtained by the “palatability enhancers” method. Ordinate: Amount of food composition consumed by the cats as a percentage. THS: very highly significant (p-value<0.001), HS: highly significant (p-value<0.01)

FIG. 5 shows a diagram illustrating the palatability of a food composition for animal consumption comprising a treated protein material as obtained by the “no concentrate” method. Abscissa: (Control Avifood) Food composition comprising commercially available treated protein, (Test) Food composition comprising the treated protein material obtained by the “no concentrate” method, (Control Obesity) Commercial cat food composition. Ordinate: Amount of food composition consumed by the cats as a percentage. S: significant (p-value<0.05), NS: not significant.

FIG. 6 shows a flowchart of the different methods for obtaining a treated protein material, which allow to increase the palatability of a food composition, from a source of protein.

### DETAILED DESCRIPTION

The present description relates to methods for treating at least one source of proteins and to a treated protein material obtainable by said methods.

According to an aspect of the disclosure, the at least one source of proteins is/are treated as follows:
(a) heating at least one source of proteins, preferably derived from an animal source;
(b) separating the material obtained in step (a) into a solid component (i) and a liquid component (ii);
(c) drying the solid component (i); and
(d) physical grinding of the material obtained in step (c);
characterized in that step (c) is performed on the solid component (i) without reintroducing the liquid component (ii).

It was found, surprisingly and advantageously, that elimination of the liquid component (i) added during step (c) of drying the solid component (i) can led to an increase in the palatability of the treated protein material obtained at the end of the method of treatment. The source of proteins, preferably the source of animal proteins, treated according to the method of the present description supplies a protein material usable in combination with other components to form, for example, a food composition for animals.

Further, it has been found that a rendering method for treating at least one source of proteins can be improved by either adding palatability enhancers to the solid component (i) at step (c) of the method and/or by adding a source of liver to the source of protein at step (a). It has been found that these modifications to the known wet rendering method can allow to obtain a treated protein material which treated protein can be used to enhance the palatability of a food composition.

As a result, a treated protein material obtainable by the methods described herein can allow the preparation of animal food compositions of enhanced palatability. In some embodiments, the presence of the said treated protein material of enhanced palatability in a food composition, generally in a pet food composition, most preferably in a cat food composition, can dispense with the addition of further additional palatability enhancers in the manufacture of the said food composition.

Food compositions for animal consumption containing treated protein material obtainable by the methods of the disclosure exhibit surprisingly high palatability to an animal and therefore can be used to increase consumption and also increase ingestion frequency by the animal, particularly for pet food compositions that otherwise are of lower palatability to an animal.

These aspects, as well as other aspects of the present description, are examined in more detail hereunder.

### 1. Definitions

The terms used in the present description generally have their ordinary meaning in this field, in the context of the disclosure and in the specific context in which each term is used. Certain terms are defined below in order to provide additional information for describing the compositions and the methods of the present description and the manner of manufacture and use thereof.

As used in the description and the accompanying claims, the singular forms “a”, “the” include the plural unless the context clearly stipulates the contrary. Thus, for example, reference to “a compound” includes mixtures of compounds.

The terms “about” or “approximately” signify that the particular value, determined by ordinary skill in the art, is within an acceptable range of error, which will partly depend on the manner in which the value is measured or determined, i.e., the limits of the system of measurement. For example, “about” may signify in a range of three or more than three standard deviations, depending on the practice in the field in question. Alternatively, “about” may signify a range of about 10% of a given value. Furthermore, in particular with regard to systems or processes, the term may signify an order of magnitude preferably of five times, and more preferably two times, a value.

The term “animal” denotes nonhuman animals, in particular canines, felines, rodents, bovines, equines, more particularly dogs and cats. The term “animal” includes the term “pet”. Preferably, in the sense of the description, an animal is a pet. Dogs and cats are particular, nonlimiting examples of pets.

The expression “source of proteins” may comprise sources of proteins of animal origin. These proteins of animal origin include, for example, without limitation, meat (for example, pork, beef or veal), poultry (for example chicken), fish, organs (for example, liver, spleen or heart), internal organs (for example, internal organs, such as viscera, of chicken or of pig) and combinations thereof.

As used in the present description, the terms “comprise”, “comprising” or any other variant of these terms, are intended to cover a nonexclusive inclusion, so that a method, a composition or a material that comprises a list of elements does not comprise only these elements but may include other elements that are not expressly enumerated or inherent in this method, this composition or this material.

In the present description, the expression “nutritionally complete” denotes food compositions for animals and/or pets that contain all the known nutrients that are necessary for the intended recipient of the food composition, in all the appropriate quantities and proportions, on the basis for example of the recommendations of the recognized authorities that are competent in the field of animal nutrition. These foodstuffs are therefore able to serve as a food source for maintaining life, without adding nutritional supplements. The term “nutritionally balanced”, as used here, refers to food compositions for pets that may be nutritionally complete. The expression “nutritionally balanced”, as used in the present description, may also refer to food compositions for pets that are not nutritionally complete.

In the present description, the terms “palatability” or “palatable” denote the fact of being desirable for the palate or taste. Furthermore, the terms “palatability” or “palatable”, as used in the present description, refer to the extent to which a food composition for pets appeals to an animal's palate or taste. This can be measured by feeding tests, for example tests of difference or classification. In certain cases, “palatability” may signify a relative preference for one food composition relative to another. For example, when an animal shows a preference for one of two or more food compositions, the food composition preferred is more “palatable” and has “enhanced palatability”. In certain cases, the relative palatability of a food composition relative to one or more other food compositions can be determined, for example, in side-by-side comparisons with free choice, for example, by the relative consumption of the food compositions, or other suitable measurements of preference indicating palatability.

The expression “food composition for animals” or “food composition for animal consumption” denotes a product or composition intended to be ingested by an animal, preferably a pet and more preferably a cat. The food compositions for animals can include, without limitation, nutritionally balanced compositions suitable for the daily ration as well as tidbits, which may be nutritionally balanced.

In the present description, the term “internal organs” denotes the intestines from an animal's body. The internal organs may moreover include other internal organs from an animal's body, for example the heart, stomach or lungs in natural proportions.

In the present description, the expression “solid component” denotes a component mainly consisting of proteins, ash and residual moisture.

In the present description, the expression “liquid component” denotes a component mainly consisting of fat and water.

In the present description, the expressions “treated protein material” or “treated protein” or “animal proteins” denote a protein material obtained as a result of a method for treating a source of protein, for example a chicken protein source. This treated protein material can be used as raw material for obtaining food compositions.

The terms “physical grinding” and “grinding” have the same meaning in the present disclosure and may be used interchangeably.

As used herein a “method for treating a source of animal protein” refers to a rendering method, such as wet rendering method or a dry rendering method. Rendering method is the process of converting animal by-products, such as carcasses, to useful treated protein material to be used in food compositions. In the rendering method, the carcasses are generally exposed to high temperatures using pressurized steam. Illustratively, rendering process is discussed in Baba et al. J Dairy Vet Anim Res. 2017; 5(1):21-27 and Woodard & amp; Curran, Inc., The Rendering Process in Industrial Waste Treatment Handbook (Second Edition), 2006.

Dry rendering process is discussed illustratively in Bennett, R. P. Oil Fat Ind 4, 275-283 (1927). The terms “dry rendering method” or “dry method” may be used interchangeably in the present disclosure. Dry rendering method illustratively allows to obtain a treated protein material having the smell of roasted chicken. For example, commercially available treated protein material is obtained by the dry method.

The terms “wet method of treatment”, “wet rendering method” or “wet method” are used interchangeably in the present disclosure.

### 2. Sources of Proteins

Wet Rendering Method

The wet rendering method for treating a source of animal protein can be adapted depending on the source of proteins which will be treated.

The wet method is a multi-step process that combine physical and thermal water removal for treating a source of proteins.

The methods of the present disclosure refer to the wet rendering method for treating at least one source of proteins comprising the following steps:
(a) heating the at least one source of animal proteins in a first vessel, thereby obtaining a pre-heated material,
(b) separating the pre-heated material obtained in step (a) into a solid component (i) and a liquid component (ii);
(c) drying the solid component (i) in a second vessel;
(d) reintroducing the liquid component (ii) in the second vessel with the solid component (i); and
(e) grinding the material obtained in step (c), thereby obtaining a treated protein material.

Step (a)

In some embodiments, the source of proteins can comprise entire or by-products poultry (chicken, turkey or duck), beef, pork, cattle or sheep. In particular, the by-products can be derived from bones, carcasses, blood, feathers, internal organs, necks, heads, or a combination thereof.

In some preferred embodiments, the source of proteins can be a by-product from poultry or a combination of several by-products from poultry.

In some embodiments, the source of proteins in step (a) can be loading in the first vessel after the reception in its original shape.

In some other embodiments, the source of proteins in step (a) can be milled or crushed to a desired maximum particle size before loading in the first vessel at step (a).

In such particular embodiments, the source of proteins can be crushed to a particle size of about 50 millimeters or less, about 40 mm or less, about 30 mm or less, about 20 mm or less, about 10 mm or less, or about 5 mm or less according to the original shape of the source of proteins to be treated.

Crushing a source of proteins can be performed by any suitable method in the art. Illustratively, bones or internal organs can be minced crushers, feathers can be cut crushers, mixed or milled.

In some embodiments, the moisture content of the source of protein should be sufficient in order to be treated in the next steps of the method. In some embodiments, the moisture content of the source of protein can be of about 50% by weight or more, 60% by weight or more or about 70% by weight or more. To adjust the moisture content, the source of protein can be mixed with a sufficient quantity of water to reach the desire moisture content.

Without wishing to be bound by any theory, a high amount of water would tend to increase the rate of the melting of the fat from the source of proteins.

In some embodiments, the time and/or the heating temperature and/or the pressure in step (a) should be sufficient to melt the fat from the source of proteins.

In some particular embodiments, the heating temperature in the first vessel can be from about 60° C. to about 150° C., from about 80° C. to about 110° C. or from about 70° C. to about 100° C.

Preferably, the heating temperature in the first vessel can be less than 100° C. It is understood that the temperature to melt the fat can be adjusted depending on the pressure applied.

The pressure generally can be about 1 bar or higher. Atmospheric pressure of about 1 bar is preferred but a higher pressure is possible to increase the degree and speed of melting the fat. Hence, the pressure can be about 2 bar or higher.

In some embodiments, the time of step (a) can be of at least 10 minutes.

In some other embodiments, the time of step (a) can be from about 10 minutes (min) to 5 hours (h), from about 10 min to about 4 h, 3 h, 2 h or 1 h or from about 10 min to about 45 min.

In some embodiments, step (a) can be performed in a closed vessel.

In some embodiments, during step (a) the water is not removed from the pre-heated material.

At the end of step (a) it is obtained a pre-heated material.

Step (b)

As mentioned, the wet rendering method comprises a step (b) which comprises separating the pre-heated material obtained in step (a) into two components; a solid component (i) and a liquid component (ii).

This step can allow to separate the protein material mainly contained in the solid component from the fat and impurities mainly contained in the liquid component.

In some embodiments, the solid component (i) and the liquid component (ii) can be separated by pressing the pre-heated material in order to substantially separate the fat from the protein material.

In some embodiments, the temperature at step (b) can be equal or cooler than the temperature used in step (a).

In some embodiments, step (b) can be performed using a screw press, a Tricanter, a decanter or any other suitable equipment for separating fat from proteins of a source of protein material.

In some preferred embodiments, step (b) can be performed using a screw press or a double-screw press.

In some embodiments, the solid component (i) can be loaded in a second vessel.

The solid component (i) generally mainly includes proteins, ashes and residual moisture of the pre-heated material.

The liquid component (ii) generally mainly includes fat, water and sometimes a lower quantity of remaining soluble proteins of the pre-heated material.

In some particular embodiments, once the solid component (i) and the liquid component (ii) are separated, it can be proceeded to a separation of remaining soluble proteins and the fat contained in the liquid component (ii).

Therefore, the liquid component (ii) can be left in the first vessel to be further processed.

In such embodiments, it can be processed to the separation of the liquid component (ii) into two fractions; a solid fraction (iii) and a liquid fraction (iv).

In these embodiments, said solid fraction (iii) generally mainly includes fat.

In these embodiments, said liquid fraction (iv) generally mainly includes water and the remaining soluble proteins.

In some embodiments, the treatment of the liquid component (ii) can be performed using a screw press, a Tricanter, a decanter or any other suitable equipment for separating fat from proteins of a material.

In some preferred embodiments, the separation of the liquid component (ii) can be performed using a screw press or a double-screw press.

Step (c)

As mentioned, the wet rendering method comprises step (c) which comprises drying the solid component (i) in a second vessel.

During step (c) the residual moisture of the solid component (i) is evaporated in order to obtain a dry protein material.

In some embodiments, step (c) can be performed in sufficient conditions of temperature and pression in order to dry the solid component (i) to a moisture content of about 15% by weight or less, preferably about 10% by weight or less, relative to the total weight of the solid component (i). Generally, drying to an amount of water lower than 4% by weight is not necessary.

In some embodiments, the drying at step (c) can be preferably performed in order to obtain a moisture content of about 1-20%, or preferably 1-10% by weight relative to the total weight of the solid component (i).

In some embodiments, step (c) can be performed at high temperature. In particular, a suitable temperature to perform the drying of step (c) can include a temperature ranging from about 65° C. to about 145° C. under atmospheric pressure. The temperature can be adapted depending on the pressure applied in the second vessel.

Step (d)

As mentioned, the wet rendering method comprises a step (d) which comprises reintroducing at least part of the liquid component (ii) in the second vessel to the solid component (i).

The liquid component (ii) can comprise fat and water of the pre-heated material.

In some embodiments, the liquid component (ii) can be reintroduced to the solid component (i) in the second vessel before step (c) and/or during step (c).

In some embodiments, only a part of the content of the liquid component (ii) can be reintroduced in the second vessel to the solid component (i). In some embodiments, at least about 50% by weight, or about 75% by weight or more of the liquid component (ii) can be reintroduced in the second vessel to the solid component (i). Generally, all the content of the liquid component can be reintroduced in the second vessel to the solid component (i).

The liquid component (ii) generally comprises mainly proteins and fat and can also comprise other minor ingredients, including impurities.

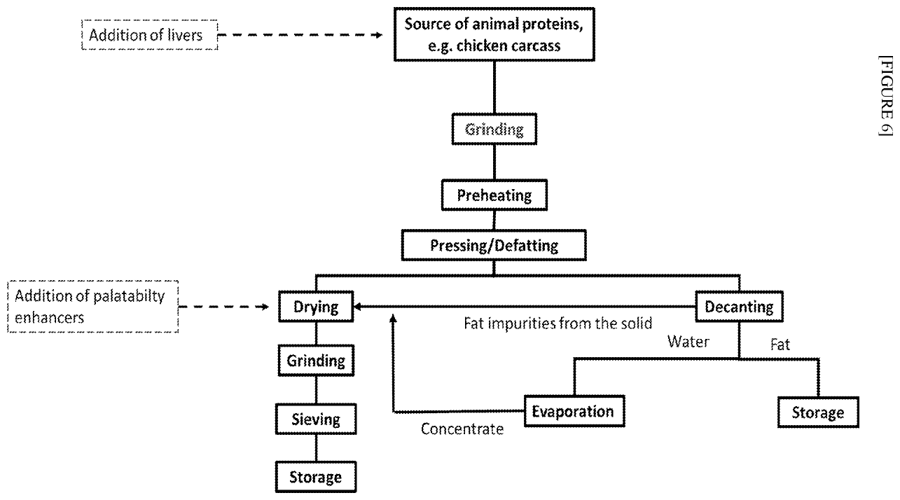

In preferred embodiments, the liquid component (ii) can be subjected to a separation step resulting in two separation fractions, (a) a liquid fraction generally mainly comprising proteins and (b) a solid fraction mainly comprising fat, as illustrated in FIG. 6.

Further, in some embodiments, the protein-containing fraction (a) can be concentrated, such as by evaporation, prior to the reintroduction in the solid component (i), as also illustrated in FIG. 6.

Thus, as mentioned above, the liquid component (ii) can be further treated to supply a solid fraction (iii) and a liquid fraction (iv).

In this embodiment, said solid fraction (iii) mainly includes fat and said liquid fraction (iv) mainly includes water and remaining soluble proteins.

In some embodiments, the treatment of the liquid component (ii) can be performed using a screw press, a Tricanter, a decanter or any other suitable equipment for separating fat from proteins of a material.

In some embodiments, the liquid fraction (iv) can be reintroduced in the second vessel to the solid component (ii).

In some preferred embodiments, the liquid fraction (iv) can be reintroduced in the solid component (i) in the second vessel before step (c) and/or during the step (c).

In some embodiments, the protein content of the liquid fraction (iv) can be only partly reintroduced in the second vessel to the solid component (i). In some embodiments, at least about 50% by weight, or about 75% by weight or more of the protein content liquid fraction (iv) can be reintroduced in the second vessel to the solid component (i). Generally, all the protein content of the liquid fraction (iv) can be reintroduced in the second vessel to the solid component (i).

In some embodiments, the liquid fraction (iv) can be concentrated, such as by evaporation, before its reintroduction in the solid component (i).

In some embodiments, the liquid fraction (iv) can be further concentrated so as to have a moisture content of about 15% by weight or less, more preferably about 10% or less.

Step (e)

As mentioned, the wet rendering method comprises a step (e) which comprises grinding the dry material obtained in step (c), thereby obtaining a treated protein material.

In some embodiments, step (e) can be optional, and the dry material obtained at step (c) can result directly in a storage stable treated protein material.

In some other embodiment, the dry material obtained at step (c) can be grinding, thereby obtaining a treated protein material suitable to be stored.

Method for Treating at Least One Source of Proteins (“No Condensate” Method)

The method of treatment in the present description is also called “wet method of treatment”. This method comprises several steps, combining physical and thermal removal of water. The source(s) of proteins are preheated in a first vat in order to melt the fat; water is not removed from the source of protein during this step. The preheated protein source can then be pressed to separate two main components, the liquid component that generally mainly contains fat and water, and the solid component that consists generally mainly of proteins, ash and residual moisture. The solid components can then be dried in another vessel, where the residual moisture is evaporated. The liquid component can then be treated/decanted, for example with a Tricanter, or any other suitable equipment that separates water from fat and from certain residual impurities. The fat can then be stored in a vat and is ready for sale. The water that has been separated mechanically in the Tricanter and that contains a certain quantity of soluble proteins can be treated in an evaporator in order to recover these proteins, if applicable. The proteins can then be added to the second vat, to be dried. The liquid is removed from the process, whereas in the prior art it is reinjected into the dryer.

According to one aspect of the present description, the method for treating at least one source of proteins comprises the following steps:
(a) heating at least one source of proteins, preferably a source of animal proteins, thus obtaining a preheated material;
(b) separating the preheated material obtained in step (a) into a solid component (i) and a liquid component (ii);
(c) drying the solid component (i), thus obtaining a pretreated protein material; and
(d) physical grinding of the pretreated protein material obtained in step (c), thus obtaining a treated protein material;
characterized in that step (c) is performed on the solid component (i) without reintroducing the liquid component (ii).

This treatment makes it possible, surprisingly and advantageously, to increase the palatability of the treated protein material obtained at the end of the method of treatment.

According to certain embodiments, the liquid component (ii) can then be treated to supply a solid fraction (iii) and a liquid fraction (iv), and the solid fraction (iii) can then be combined with the solid component (i) before step (c) or step (d).

According to certain embodiments, step (b) can be performed using a screw press, a Tricanter, a decanter or any other suitable equipment, preferably a screw press, and more preferably a double-screw press and all combinations thereof.

According to certain embodiments, step (c) can be performed in a dryer.

According to certain other embodiments, step (c) can be performed in a dryer operating at a temperature between about 65° C. and about 145° C.

Method for Treating at Least One Source of Protein and Obtaining a Treated Protein Material

According to another aspect, the present disclosure also relates to a method for obtaining a treated protein material.

Specifically, the method for obtaining a treated protein material can be based on the wet rendering method as described in the present disclosure in which it can be further added a quantity of one or more palatability enhancer to the solid component (i) and/or in which it can be further added a quantity of liver to the source of proteins.

The method for obtaining a treated protein material based on the wet rendering method as described herein in which it can be added a quantity of palatability enhancers to the solid component (i) is also called “palatability enhancers” method.

The method for obtaining a treated protein material based on the wet rendering method as described in which it can be added a quantity of liver to the source of proteins is also called “liver” method.

“Palatability Enhancer” Wet Rendering Method

The present disclosure relates to a method for obtaining a treated protein material comprising the following steps:
(a) heating the at least one source of animal proteins in a first vessel, thereby obtaining a pre-heated material;
(b) separating the pre-heated material obtained in step (a) into a solid component (i) and a liquid component (ii);
(c) drying the solid component (i) with a quantity of palatability enhancers;
(d) reintroducing the liquid component (ii) in the second vessel to the solid component (i); and
(e) grinding of the dried mixture obtained in step (d) thereby obtaining a treated protein material.

In some embodiments, step (c) of the wet rendering method can be performed on the solid component (i) without reintroducing the liquid component (ii).

In some embodiments, step (c) of the wet rendering method can be performed on the solid component (i) without reintroducing the liquid fraction (iv).

In some embodiments, step (c) of the wet rendering method can be performed on the solid component (i) in which has been reintroduced the liquid fraction (iv).

In some embodiments, step (d) can be optional in the wet rendering method of the disclosure.

In some embodiments, a quantity of liver can be added to the at least one source of proteins in step (a).

In some embodiments, a quantity of fat can be added to the liquid fraction (iv) during its further drying at step (d).

In some embodiments, the one or more palatability enhancer can be chosen among a quantity of at least one source of amino acids and at least one source of sugar, a quantity of fat, a quantity of yeast, a quantity of enzymes and/or a combination thereof.

In some embodiments, the palatability enhancer can be a quantity of at least one source of amino acids and at least one source of sugar (“AA+sugars” method).

Specifically, in such embodiments, a Maillard reaction is conducted.

Generally, a Maillard reaction is a chemical reaction between an amino acid (one category of an amine reactant) and a reducing sugar that often requires added heat to promote the reaction. It is known to involve a non-enzymatic browning where a reactive carbonyl group of the reducing sugar reacts with the nucleophilic amino group of the amino acid.

In certain embodiments, amino acids suitable for the present method includes natural and synthetic amino acids.

In some embodiments, amino acids can include biogenic amino acids such as alanine, aminobutyric acid, arginine, asparagine, aspartic acid, cysteine, cystine, dibromotyrosine, diiodotyrosine, glutamic acid, glutamine, histidine, homocysteine, hydroxylysine, hydroxyproline, isoleucine, leucine, lysine, methionine, ornithine, phenylalanine, proline, sarcosine, serine, threonine, thyroxine, tryptophane, tyrosine, and valine, and all potential dimers, oligomers and polymers made from such amino acids.

In some other embodiments, amino acids can include synthetic amino acids including aminobenzoic acid, aminosalicylic acid, aminoundecanoic acid and all potential dimers, oligomers and polymers made from them.

In some preferred embodiments, the amino acids added in step (c) can be selected from lysine, cysteine, glycine, methionine or a combination thereof.

In some embodiments, the source of amino acids can be selected among by-product animals.

In some embodiments, the sugars added in step (c) can be a reducing sugar.

In some particular embodiments, the reducing sugar can include carbohydrates having, or capable of generating a reducing sugar during the step (c).

Generally, a reducing sugar is a carbohydrate that either contains an aldehyde group or can be isomerized.

In some preferred embodiments, the sugars can be selected from xylose, dextrose or a combination thereof.

In some embodiments, the source of sugars can be supplied under the form of any of a variety of sugar sources known by those skilled in the art. For instance, as non-limitative example, it can be used starch (corn, wheat, barley, etc.) or beet pull.

In some embodiments, the amino acids and sugars can be added to the solid component (i) in an amount of at least about 0.01% by weight on a dry matter basis. Generally, amino acids and sugars can be added to the solid component (i) in an amount ranging from about 0.01% to about 5% by weight on a dry matter basis. In certain embodiments, the amount of amino acids and sugars added to the solid component (i) can be ranging from about 0.01% to about 1% by weight on a dry matter basis. In other embodiments, the amount of amino acids and sugars added to the solid component (i) can be preferably in a proportion of about 0.3% by weight on a dry matter basis.

In some embodiments, the palatability enhancer can be a quantity of yeast.

In some particular embodiments, the yeast can be active, semi-active or inactive.

In some embodiments, the yeast can be added to the solid components in an amount of at least about 0.010% by weight on a dry matter basis. Generally, yeast can be added to the solid component (i) in an amount of about 0.01% to about 2% by weight on a dry matter basis. In certain embodiments, the amount of yeast compound added to the solid component (i) can be from about 0.02% to about 1% by weight on a dry matter basis. In other embodiments, the amount of yeast added to the solid component (i) can be from about 0.05% to about 0.5% by weight on a dry matter basis.

Any type or form of yeast that is compatible with a consumption by an animal can be used in the present disclosure. Examples of suitable yeasts can include, but are not limited to brewer's yeast, nutritional yeast and torula yeast.

In some embodiments, a yeast suitable to be a palatability enhancer can be a yeast of the genus Candida and/or of the genus Saccharomyces.

In some embodiments, the yeast suitable to be a palatability enhancer can be chosen among the species; Saccharomyces bailii, Saccharomyces carlsbergensis, Saccharomyces cerevisiae, Saccharomyces delbrueckii, Saccharomyces uvarum, Saccharomyces exiguus, Saccharomyces fermentati, Saccharomyces florentinus, Saccharomyces fragilis, Saccharomyces fructuum, Saccharomyces heterogenicus, Saccharomyces oleaginosus, Saccharomyces rosei, Saccharomyces steineri, Saccharomyces boulardii, Saccharomyces kefir, Saccharomyces kluyveri, Candida albicans, Candida dubliniensis, Candida glabrata, Candida guilliermondii, Candida kefyr, Candida krusei, Candida lusitaniae, Candida parapsilosis, Candida tropicalis or a combination thereof.

In some embodiments, when the palatability enhancer is a yeast, the pH during step (c) should be within the working range of the yeast used.

In some embodiments, when the palatability enhancer is a yeast, the pH during step (c) can be within about 2 to about 10. In other embodiment, the pH can be within about 6 to about 8.

In some embodiments, when the palatability enhancer is a yeast, the temperature during step (c) should be within the working range of the yeast used

In some embodiments, when the palatability enhancer is a yeast, step (c) can be performed in anaerobic conditions, substantially anaerobic conditions or in aerobic conditions.

In some embodiments, the palatability enhancer can be a quantity of enzyme.

In such embodiments, the solid component (i) can be combined with a quantity of enzyme to increase the palatability of the resulting treated protein material and also to increase the digestibility of the resulting treated protein material.

In some embodiments, the enzyme can be added to the solid component (i) in an amount at least sufficient to achieve the intended effect, but the upper limit to the amount of enzyme included is not particularly critical.

In some embodiments, an enzyme added to the solid component (i) for practicing the present method can be obtained from any suitable bacteria, such as Bacillus sp.

In some embodiments, an enzyme used as a palatability enhancer can be in crude form or in pure form.

In some particular embodiments, enzymes in crude form can be prepared, for example, by separating bacterial cells which produce the enzyme from their liquid growth media, the liquid growth media comprising crude enzyme. Alternatively, the cells can be lysed (chemically or physically) in a liquid growth media to produce a crude, cell free extract. Other means of preparing such an extract will be apparent to persons skilled in the art. The crude enzyme can be included in the feed in any form compatible therewith, such as in an aqueous form or in lyophilized form.

In some particular embodiments, enzymes in pure (or substantially pure) form can be obtained by separating the crude enzyme described above into its individual constituents, in accordance with known techniques. Numerous suitable separation procedures, such as column chromatography, are known to persons skilled in the art. Like the crude enzyme, the pure enzyme can be employed in any suitable form, including aqueous form and lyophilized form.

In some embodiments, an enzyme can be a protease such as a serine protease, a cysteine protease, a threonine protease, an aspartic protease, a glutamic protease, a metalloprotease, or an asparagine peptide lyase.

In preferred embodiments, an enzyme can be a keratinase.

In some embodiments, when the palatability enhancer is an enzyme, the pH during step (c) should be within the working range of the enzyme used.

It is a matter of routine to a person of ordinary skill in the art to determine the optimal working range of the enzyme used and to add buffer to adjust the reaction solution to an appropriate pH. Illustratively, as a non-limitative example, the working range of the protease Protex 30 L (available from DuPont Industrial Biosciences ApS) can be from about 5.5 to about 12. Therefore, when Protex 30 L may be used as the palatability enhancer, the pH during the drying step (c) can be from about 5.5 to about 12.

In some embodiments, the pH used in step (c) is the optimal pH of the enzyme.

In some embodiments, when the palatability enhancer is an enzyme, the temperature during step (c) should be within the working range of the enzyme used.

It is a matter of routine to a person of ordinary skill in the art to determine the optimal working range of the enzyme used and to carry out the reaction at a desired temperature. Illustratively, the working range of the protease Protex 30 L can be from about 30° C. to about 80° C. When Protex 30 L is used as the protease, the temperature during the admixing step can be from about 30° C. to about 80° C.

Generally, when the palatability enhancer is an enzyme, the enzymes used can be selected to have overlapping working ranges with the conditions of step (c). Preferably, the enzymes can be selected to have compatible, preferably similar working ranges as those of step (c).

In some embodiments, more than one enzyme can be present as palatability enhancer. In this case, the temperature, pH and other conditions used can be selected to be within the working ranges of the enzymes used.

In some embodiments, the palatability enhancer can be a quantity of fat.

Specifically, a quantity of fat is provided by a source of fat.

In these embodiments, a quantity of fat can be added in the second vessel to the solid component (i) to be dried.

In some embodiments, the fat can be added to the solid component (i) in an amount of at least about 0.01% by weight on a dry matter basis. Generally, fat can be added to the solid component (i) in an amount of about 0.01% to about 10% by weight on a dry matter basis. In certain embodiments, the amount of fat added to the solid component can be from about 0.010% to about 5% by weight on a dry matter basis. In other embodiments, the amount of fat added to the solid component (i) can be from about 0.05% to about 3% by weight on a dry matter basis.

In such embodiments, a further separating step is applied after step (c), before step (e) in order to remove the fat from the material obtained in step (c).

In some embodiments, a source of fat can be an animal sources including, for example and without limitation, chicken fat, turkey fat, beef fat, duck fat, pork fat, lamb fat, etc., fish oil or any meat, meat by-products, seafood, dairy or eggs.

“Liver” Wet Rendering Method

In some other embodiments, the present disclosure relates to a “liver” method for obtaining a treated protein material comprising the following steps:
(a) heating the at least one source of animal proteins with a source of liver in a first vessel, thereby obtaining a pre-heated material;
(b) separating the pre-heated material obtained in step (a) into a solid component (i) and a liquid component (ii);
(c) drying the solid component (i);
(d) reintroducing the liquid component (ii) in the second vessel to the solid component (i); and
(e) grinding of the dried mixture obtained in step (d) thereby obtaining a treated protein material.

In some embodiments, the source of liver can be selected from lamb liver, poultry liver, beef liver, pork liver, or a mix thereof, in particular a poultry liver.

In some embodiments, the amount of liver can be added to the source of protein in an amount of at least about 0.010% by weight on a dry matter basis. Generally, the amount of liver can be added to the source of protein in an amount ranging from about 0.01% to about 10% by weight on a dry matter basis. In certain embodiments, the amount of liver added to the source of protein can be ranging from about 0.5% to about 7% by weight on a dry matter basis. In other embodiments, the amount of liver added to the source of protein can be in a proportion of about 5% by weight on a dry matter basis.

It is intended that all the particular features and embodiments described in the different parts of the present disclosure can applied to all the different methods of the present disclosure.

Sources of Animal Proteins

According to certain embodiments, the source or sources of proteins can include animal proteins, proteins of animal origin or combinations thereof. The source or sources of proteins can include sources of animal proteins such as chicken or swine. The source or sources of proteins can include, for example, the trachea, kidneys, liver or internal organs. When used here, the term “protein” refers to one or more proteins supplied appropriately by one or more of the raw material. It can be animal proteins, proteins of animal origin or any combination thereof. The animal proteins can comprise any protein of animal origin (including proteins from vertebrates and invertebrates), for example proteins derived from mammals, poultry, fishes and insects. Among the examples of suitable animal proteins, it can be mentioned those that are derived from chicken, turkey, steer, lamb, swine, stag, buffalo, duck, kangaroo, shellfish, salmon, tuna, whitefish, etc. They may be derived from muscle meat, organs, tendons, bones, etc. The proteins can be in any suitable form, for example isolated or partially isolated, concentrated, ground, etc. For example, and without limitation, the source or sources of proteins can include one or more of the following sources: pig trachea, pig kidney, parts of poultry, chicken liver, chicken internal organs, chicken necks, organs, turkey carcasses, or combinations of these sources. Regarding the embodiments, the source or sources of proteins can include, for example, liver of chicken, of turkey, of pig, of steer, of lamb or of fish. A person skilled in the art will appreciate the great variety of sources of proteins that can be used within the scope of the present description.

According to certain embodiments, the source of proteins can be selected from bones, carcasses, internal organs, necks or heads, or a combination thereof.

According to certain embodiments, the source of proteins can be chicken.

According to certain embodiments, the source of proteins can be ground to a desired maximum particle size before step (a).

According to certain embodiments, the source of proteins can be cooled or refrigerated before treatment.

According to certain embodiments, water can be removed at least partially from the source of proteins.

According to certain embodiments, one or more sources of animal proteins can be combined with one another.

Characteristics of the Treated Protein Material

The method of the present description makes it possible, surprisingly and advantageously, to obtain a treated protein material that is highly palatable to an animal, preferably a cat and/or a dog. By eliminating the step of reintroduction of the liquid component (ii) in step (c), the loss of taste of the treated protein material is reduced significantly. Furthermore, the quality of food compositions for animals, preferably for pets, can be improved by obtaining treated protein material that is more palatable for an animal by carrying out the method of the present description.

The other methods of the present disclosure also allow to obtain a treated protein material that is highly palatable to an animal, preferably a cat and/or a dog.

According to certain embodiments, the treated protein material can have a level of histamine from 0 ppm to about 500 ppm, from about 10 ppm to about 300 ppm, from about ppm to about 200 ppm, or from about 10 ppm to about 150 ppm. In particular, according to certain embodiments, the treated animal protein can have a level of histamine of 0 ppm, about 10 ppm, about 15 ppm, about 50 ppm, about 100 ppm, about 125 ppm, about 150 ppm, about 200 ppm, about 250 ppm, about 275 ppm, about 300 ppm or about 500 ppm. According to certain embodiments, the treated animal protein can have a level of histamine below about 500 ppm, below about 300 ppm, below about 250 ppm, below about 200 ppm, below about 100 ppm, below about 50 ppm, or below about 25 ppm.

According to certain embodiments, the treated protein material can have a level of histamine from 0 mg/kg to about 200 mg/kg, from about 10 mg/kg to about 150 mg/kg, from about 10 mg/kg to about 90 mg/kg, or from about 10 mg/kg to about 50 mg/kg. In particular, according to certain embodiments, the treated animal protein material can have a level of histamine of 0 mg/kg, about 1 mg/kg, about 5 mg/kg, about 10 mg/kg, about 15 mg/kg, about 25 mg/kg, about 50 mg/kg, about 100 mg/kg, about 125 mg/kg, about 150 mg/kg, or about 200 mg/kg.

According to certain embodiments, the treated animal protein material can have a level of histamine below about 200 mg/kg, below about 150 mg/kg, below about 100 mg/kg, below about 90 mg/kg, below about 50 mg/kg, below about 25 mg/kg, below about 15 mg/kg, below about 10 mg/kg, below about 5 mg/kg, below about 2 mg/kg or below about 1 mg/kg.

The methods for measuring the amount of histamine, and other biogenic amines such as putrescine, cadaverine, spermine, spermidine, tyramine, tryptamine, 2-phenylethylamine, serotonin or agmatine, and hexanal are familiar to a person skilled in the art.

According to certain embodiments, the treated protein material is as palatable as roast chicken for a pet, preferably a cat and/or a dog.

### 3. Food Compositions for Animals

According to another embodiment, the present description relates to a food composition obtainable by the method according to the present description.

According to another aspect, the present description relates to a food composition for animals. The food composition for animals can include one or more treated protein material according to the present description and, optionally, one or more additional ingredients, for example dry ingredients, liquid ingredients, or combinations thereof. A person skilled in the art will appreciate the great variety of compositions of foodstuffs for pets that can be used within the scope of the present description.

The food composition can comprise proteins, carbohydrates and/or raw fats. The food compositions for animals can also contain additives or supplements, for example minerals, vitamins and condiments. These food compositions for animals may or may not be nutritionally complete. According to one embodiment, a food composition for animals can be, according to the present description, a nutritionally complete food composition.

In a particular embodiment, a food composition of the disclosure can consist of a dry animal food composition. In a preferred embodiment, the dry food composition can consist of a kibble. For example, and without limitation, kibbles can include particulates; pellets; pieces of pet food, dehydrated meat, meat analog, vegetables, and combinations thereof, and pet snacks, such as meat or vegetable jerky, rawhide, and biscuits. The dry food composition can be manufactured by mixing together ingredients and kneading in order to make consistent dough that can be cooked. In general, it can be the final composition of a process comprising an extrusion step followed by a drying step.

In a particular embodiment, a food composition according to the disclosure is palatable for animals such as cats or dogs.

According to some embodiments, a food composition of the disclosure may be in any form selected from a functional food, a dietary, a food additive, a food preservative, a supplement, a drug, a foodstuff, or a nutritionally complete food composition.

### 4. Methods of Manufacturing Food Compositions for Animals

According to another aspect, the present description relates to a method of manufacturing food compositions for animals.

According to certain nonlimiting embodiments, one or more dry ingredients can be mixed with one or more wet ingredients to form an emulsion or a paste. The emulsion or paste can be heated under pressure to a predetermined temperature and cooled gradually. An emulsion can also be formed, which may be ground and heated to a predetermined temperature, and then fed into a treatment zone. In the treatment zone, the emulsion can be subjected to a predetermined pressure and discharged. To produce a composition in pieces, a slurry can also be fed into a scraped heat exchanger at a predetermined pressure and then heated to obtain a composition that is heat-treated at a certain temperature.

According to certain nonlimiting embodiments, one or more dry ingredients can be mixed with one or more wet ingredients, for example water, to form a paste. The paste can be cooked during extrusion in conditions of high temperature, high pressure or a combination thereof. The extruder can be equipped with a die having a particular shape and the extrudate can be segmented into particles or pieces as the product is extruded.

A person skilled in the art will appreciate the great variety of methods for making food compositions for animals that are suitable for the present description.

In particular, a method of manufacturing a food composition comprises the steps of:
a) mixing a treated protein material obtainable by a method of the present disclosure with suitable ingredients for a nutritionally complete food composition, thereby providing a mixture; and
b) heating the mixture.

In particular, a method of manufacturing a food composition comprises the steps of:
a) mixing a treated protein according to the method of the present disclosure with suitable ingredients for a nutritionally complete food composition, thereby providing a mixture; and
b) heating the mixture.

### 5. Use of the Treated Protein Material as a Palatability Enhancer

The treated protein material according to the present description can be used as raw material with other components to form a food composition for animals, preferably for pets.

The treated protein material according to the present description can be used as protein material and palatability enhancer with other components to form a food composition for animals, preferably for pets.

According to certain nonlimiting embodiments, the food composition for animals can be used alone as a food composition for animals or in combination with other components to form a mixed food composition for animals.

Any suitable application of food compositions for animals can be used with the treated protein material of the present description, preferably the treated protein material obtainable by the method of treatment in the present description. For example, without it being limiting, the treated protein material according to the present description can be used in dry or wet products, such as mousses or pates or pieces in sauce or jelly, tidbits, baked products or food compositions for pet pillows.

According to another aspect, the present description relates to a method for manufacturing a food composition for animal consumption, preferably for pets, comprising the following steps:
(I). mixing a treated protein material obtainable according to the methods of the present disclosure to at least one ingredient suitable for preparing a food composition for animal consumption; and
(II). treating the mixture obtained in step (I) to supply a food composition for animals.

In some embodiments, the method can comprise a further step (III) wherein the ingredients in step (I) do not comprise further palatability enhancers, such as naturel or artificial aromas.

In some embodiments, wherein the at least one ingredient can be selected from moisture, a source of fats, a source of ashes, a source of fibers, a source of carbohydrates, a source of EPA/DHA, a source of starch or a combination thereof.

### EXAMPLES

In the following examples, the palatability of the food compositions for animals was measured as follows.

### Example 1: Evaluation of the Consumption of Food Compositions by Animals

A classification test was used for evaluating the consumption of the food compositions by cats following a monadic (single) presentation of the food composition. A test with a crossover design was used in order to ensure that all the food compositions were tested on each day of the test. Each food composition was classified alongside the others as a function of its consumption. The classification test was used for evaluating 2 food compositions simultaneously.

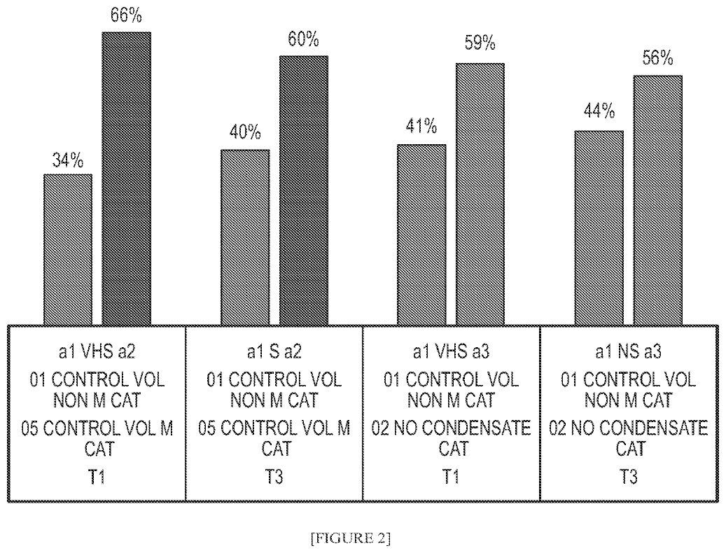

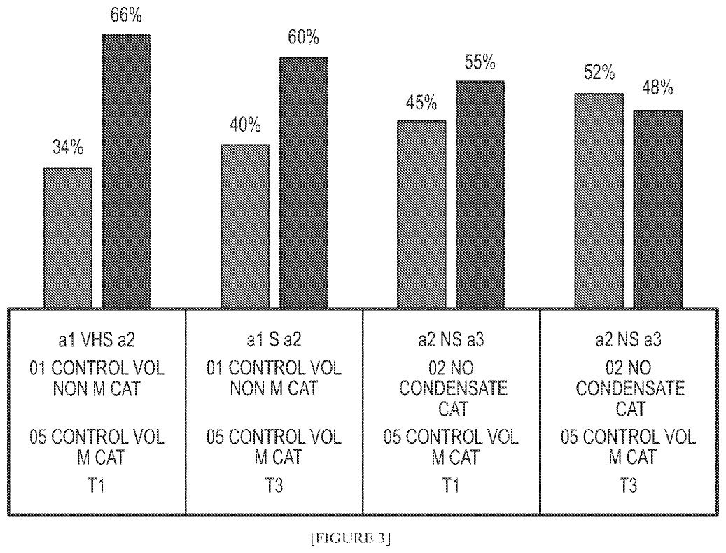

The test results are presented in FIGS. 2 and 3.

### Example 2: Results

When the liquid component (called “NO CONDENSATE” in FIGS. 2 and 3) was removed, an increase in the palatability of the food composition comprising the treated protein material was observed. This increase in palatability reaches the level of the product that is best known for palatability, roast chicken.

It will be obvious to a person skilled in the art that various modifications and variations can be made to the systems and methods of the subject matter disclosed while remaining within the spirit or scope of the subject matter disclosed. Thus, it is envisaged that the subject matter disclosed can comprise modifications and variations that fall within the field of application of the accompanying claims and their equivalents.

### Example 3: Further Evaluation of the Consumption of Food Compositions by Cats

This example demonstrates the effect of a treated protein material obtained by the methods of the disclosure as a protein source and palatability enhancer when added to a dry cat food composition (control).

The control dry cat food composition was comprising dehydrated poultry protein, maize, wheat, rice, animal fats, wheat gluten, hydrolyzed Poultry Protein, beet pulp, maize gluten, vegetable fibers, fish oil, minerals, vitamins and soya oil.

Four test food compositions were compared against the control food composition in a palatability test as described in example 1. The “no condensate” test cat food composition was comprising the control composition with dehydrated poultry protein substituted with the treated protein material obtained by the “no condensate” method; the “liver” test cat food composition was comprising the control composition with dehydrated poultry protein substituted with the treated protein material obtained by the “liver” method; the “AA+sugar” test cat food composition was comprising the control composition with dehydrated poultry protein substituted with the treated protein material obtained by the “palatability enhancer” method; and the “Bic meal” test cat food composition was comprising the control composition with dehydrated poultry protein substituted with commercially available protein material.

Protein material used in the control is considered as the best palatable dehydrated proteins obtained by a dry rendering method. It is similar to the roasted chicken in terms of taste for animals.

Palatability was determined by comparing the test cat food compositions and the control cat food composition in a classification test over two consecutive days with 33 cats for each test.

The tests were conducted by providing the cats access to equal amounts of a single test food composition and the control food composition at the same time. The tests were conducted with the same external temperature for both days in the middle of the week. At the end of the day, the food compositions were collected and weighed to determine how much of each composition was consumed. A test with a crossover design was used in order to ensure that all the food compositions were tested on each day of the test. Each food composition was classified alongside the others as a function of its consumption.

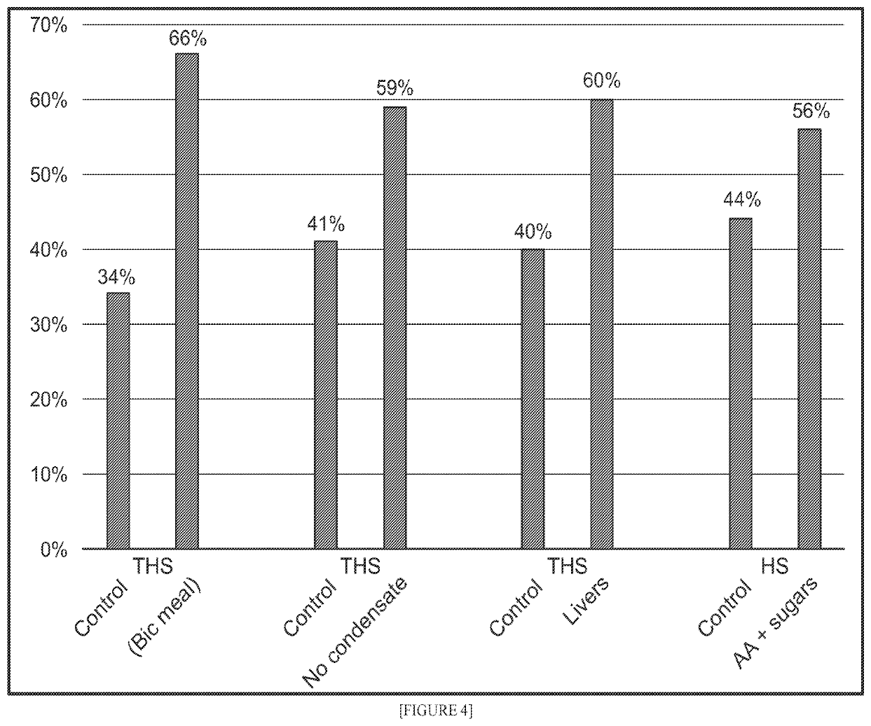

Results are shown in FIGS. 4 et 6.

The results show that test food compositions were much better preferred by the cats then the control food composition.

Consequently, these tests confirm that when the liquid component in the method for obtaining treated protein material is removed and not reintroduce, the supplied food composition has a better palatability.

Further, these results demonstrate that treated protein material obtained with either the introduction of a quantity of liver or of a quantity of amino acids and sugars in the method allows to obtain a palatable protein material which can also be used as a palatability enhancer.

### Example 4: Evaluation of the Consumption of a Commercial Food Compositions by Cats

This example demonstrates the effect of a treated protein material obtained by the method “no condensate” as a protein source and palatability enhancer when added to a dry commercial cat food composition Obesity® (control).

The control Obesity® dry food composition was comprising dehydrated poultry protein, vegetable fibers, tapioca, wheat flour, hydrolysed animal proteins, wheat gluten, maize gluten, animal fats, chicory pulp, minerals, psyllium husks and seeds, fish oil, marigold extract (source of lutein), glucosamine, hydrolysed cartilage (source of chondroitin).

Two control food compositions were compared against the test food composition in a palatability test as described in example 3. The test cat food composition was comprising the control Obesity® composition with dehydrated poultry protein substituted with the treated protein material obtained by the “no condensate” method of the disclosure; the control food composition was comprising the control Obesity® composition with dehydrated poultry protein substituted with commercially available protein material.

Protein material used in the control is considered as the best palatable dehydrated proteins obtained by the dry rendering method. It was similar to the roasted chicken in terms of palatability for animals.

Palatability was determined by comparing the test cat food composition and the control cat food compositions in a classification test over two consecutive days with 33 cats.

The tests were conducted by providing the cats access to equal amounts of a single test food composition and a control food composition at the same time or the two control food compositions at the same time. The tests were conducted with the same external temperature for both days in the middle of the week. At the end of the day, the food compositions were collected and weighed to determine how much of each composition was consumed. A test with a crossover design was used in order to ensure that all the food compositions are tested on each day of the test. Each food composition was classified alongside the others as a function of its consumption.

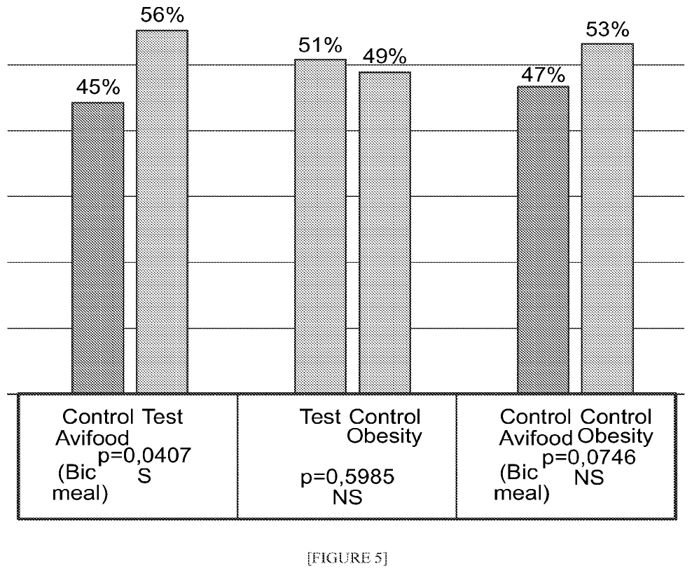

Results are shown in FIG. 5.

The results show that the food composition comprising a treated protein material obtained by the “no concentrate” method has a better palatability than the control food composition comprising commercially available treated protein material.

Then, this test confirms that when the liquid component in the method for obtaining treated protein material is removed and not reintroduce, the supplied food composition has a better palatability. This increase in palatability even reaches a better level of palatability than the most famous product for its palatability, dehydrated protein material obtained by the dry rendering method.

In the description, there have been disclosed preferred embodiments of the disclosure and, although specific terms are employed, they are used in a generic and descriptive sense only and not for purposes of limitation, the scope of the disclosure is defined in the following claims. Obviously, several modifications and adaptations of the present disclosure are possible considering the above teachings. It is therefore to be understood that within the scope of the appended claims the methods of the disclosure may be practiced otherwise than as specifically described.

### Example 5: Evaluation of the Sensory Molecules from the Treated Protein Material Obtained with the “No Concentrate” Method Described Herein

A. Materials and Methods

Any method well known by the person skilled in the art can be used. More particularly, the used methide herein is the method GC-MS/FID (gas chromatography-mass spectrometry-flame ionization detector) with extraction SPME (solid-phase microextraction). Illustratively, such method is discussed in Charry-Parra et al. Journal of Food Science 76(2):C205-11; March 2011; DOI:10.1111/j.1750-3841.2010.01979.x; Beer volatile analysis: optimization of HS/SPME coupled to GC/MS/FID.

B. Results

TABLE 1
Molecules removed from the treated protein
material and the associated smell

| | |
|---|---|
| Molecule removed with the | isobutyraldehyde |
| concentrate | pentanal |
| | hexanal |
| | heptanal |
| | 2-heptenal |
| | octanal |
| | 2-octenal |
| | nonanal |
| | benzeneacetaldehyde |
| | 1-octen-3-ol |
| | acide acetique |
| | acide propanoique |
| | acide butanoique |
| | acide 3-methyl butanoique |
| | acide 2-methyl butanoique |
| | 2-butanone |
| | 2-heptanone |
| | 2-octanone |
| | 2-nonanone |
| | 2-decanone |
| | dimethyl disulfide |
| | ethyl benzene |
| | dodecane |
| Sensory Descriptors removed | animal |
| with the concentrate | fecal |
| (evaluation done by an expert | offals |
| sensory panel) | moldy |
| | cheese |

As shown in the present Table 1, the “no concentrate” methos of the present description has improved the sensory properties of the treated protein material by eliminating sensory molecules that are detrimental to the treated protein material.

1. A method for treating at least one source of proteins comprising the steps of:
(a) heating at least one source of proteins;
(b) separating the material obtained in step (a) into a solid component (i) and a liquid component (ii);
(c) drying the solid component (i); and
(d) physical grinding of the material obtained in step (c);
characterized in that step (c) is performed on the solid component (i) without reintroducing the liquid component (ii).

2. The method of claim 1, wherein the source of proteins is selected from bones, carcasses, internal organs, necks or heads, or a combination thereof, and/or the animal source is chicken.

3. (canceled)

4. The method of claim 1, wherein the liquid component (ii) is then treated to supply a solid fraction (iii) and a liquid fraction (iv), and in which the solid fraction (iii) is then combined with solid component (i) before step (c) or step (d).

5. The method of claim 1, wherein step (a) comprises heating the at least one source of proteins to a temperature at which the fat contained in the source of proteins are molten.

6. The method of claim 1, wherein step (b) is performed using a screw press, a Tricanter, a decanter or any other suitable equipment, preferably a screw press, and preferably a double-screw press.

7. The method of claim 1, wherein step (c) is performed in a dryer, at a temperature between 65° C. and 145° C.

8. (canceled)

9. A method for obtaining a treated protein material comprising:
(a) heating at least one source of proteins;
(b) separating the material obtained in step (a) into a solid component (i) and a liquid component (ii);
(c) drying the solid component (i) with at least on source of amino acids and/or at least one source of sugar; and
(d) reintroducing the liquid component (ii) in the second vessel to the solid component (i); and,
(e) grinding of the dried mixture obtained in step (d) thereby obtaining a treated protein material.

10. The method of claim 9, wherein the source of animal proteins is selected from bones, carcasses, internal organs, necks or heads, or a combination thereof.

11-13. (canceled)

14. The method of claim 9, wherein the amino acids in step (c) are selected from lysine, cysteine, glycine, methionine or a combination thereof.

15. The method of claim 9, wherein the sugar in step (c) is selected from xylose, dextrose or a combination thereof.

16. The method of claim 9, wherein the amino acids and/or sugars are added in step (c) in an amount ranging from about 0.01% to about 1% by weight on a dry matter basis.

17-18. (canceled)

19. The method of claim 9, wherein step (d) is performed at a pH from about 6 to about 8.

20. The method of claim 9, wherein the mixture has a moisture content ranging from about 30% to about 60% by weight of the mixture.

21. The method of claim 9, in which step (d) is performed at a temperature of about 100° C. to about 200° C.

22-23. (canceled)

24. A method for obtaining a treated protein material comprising:
(a) heating at least one source of animal proteins to a source of liver in a first vessel, thereby obtaining a pre-heated material;
(b) separating the pre-heated material obtained in step (a) into a solid component (i) and a liquid component (ii);
(c) drying the solid component (i); and
(d) reintroducing the liquid component (ii) in the second vessel to the solid component (i); and
(e) grinding of the dried mixture obtained in step (d) thereby obtaining a treated protein material.

25. The method of claim 24, wherein the source of animal proteins is selected from bones, carcasses, internal organs, necks or heads, or a combination thereof.

26. The method of claim 24, wherein the source of liver is selected from lamb liver, poultry liver, beef liver, pork liver, or a mix thereof.

27. The method of claim 24, wherein, at step (a), the animal liver is in an amount of about 5% by weight on a dry matter basis.

28-33. (canceled)

34. The method of claim 1, wherein the method further comprises manufacturing a food composition for animal consumption comprising the following steps:
(I). mixing the protein material obtained according to the method with at least one ingredient suitable for preparing a food composition for animal consumption; and
(II). treating the mixture obtained in step (I) to supply a food composition for animals.

35. The method of claim 34, wherein the at least one ingredient is selected from moisture, a source of fats, a source of ashes, a source of fibers, a source of carbohydrates, a source of EPA/DHA, a source of starch or a combination thereof.

36. (canceled)
